(19) United States
(12) Patent Application Publication
(10) Pub. No.: US 2026/0237620 A1
(43) Pub. Date: Aug. 13, 2026

(54) MASS SPECTROMETRY METHOD AND MASS SPECTROMETER

(71) Applicant: SHIMADZU CORPORATION, Kyoto-shi (JP)

(72) Inventor: Takeshi ASHIDA, Kyoto-shi (JP)

(21) Appl. No.: 19/153,472

(22) PCT Filed: Feb. 23, 2023
(86) PCT No.: PCT/JP2023/003549

§ 371 Date: Aug. 4, 2025

(51) Int. Cl. H01J 49/00

(52) U.S. Cl. CPC H01J 49/0036; H01J 49/004

(57) ABSTRACT

A mass spectrometry method comprising: performing an MS scan measurement of a target compound (Step 2); selecting one or more precursor ion candidates from among detected ions based on a first criterion regarding measured intensity (Step 5); performing an MS/MS scan measurement using each precursor ion candidate (Step 6); selecting product ion candidates from among detected product ions based on a second criterion regarding measured intensity (Step 9); and determining a pair of a precursor ion candidate and a product ion candidate as an MRM transition (Step 10). In the MS scan measurement and/or the MS/MS scan measurement, a mass resolution in a high mass-to-charge ratio or high mass-to-charge ratio range is made lower than a mass resolution in a low mass-to-charge ratio or low mass-to-charge ratio range, in a mode that increases a measurement sensitivity in the high mass-to-charge ratio or high mass-to-charge ratio range

### TECHNICAL FIELD

The present invention relates to a mass spectrometry method and a mass spectrometer.

### BACKGROUND ART

To identify or quantify a target compound contained in a sample, MRM measurement using a mass spectrometer is performed (see, for example, Patent Literature 1). In an MRM measurement, ions having a predetermined mass-to-charge ratio are selected as precursor ions from among ions generated from a sample, the precursor ions are fragmented to generate product ions, ions having a predetermined mass-to-charge ratio are selected as product ions from among the generated product ions, and their intensity is measured. The pair of a precursor ion and a product ion used in an MRM measurement is called an MRM transition. The target compound is identified based on the measured intensity ratio of a plurality of MRM transitions. Furthermore, the target compound is quantified based on the measured intensity of an MRM transition.

If MRM measurement conditions including the MRM transition of a target compound are recorded in an existing database, the MRM measurement can be executed by reading the MRM measurement conditions from the database. On the other hand, if the MRM measurement conditions of the target compound are not recorded in the database, the analyst must determine the MRM transition of the target compound themselves. When determining an MRM transition, first, an MS scan measurement of the target compound is performed to measure the intensity of ions generated from the target compound, and one or more ions with high measured intensity are selected as precursor ion candidates. Subsequently, an MS/MS scan measurement is performed using each of the one or more precursor ion candidates, and the intensity of the product ions generated from each precursor ion candidate is measured. Then, for each precursor ion candidate, one or more product ion candidates with high measured intensity are selected, and the combination of a precursor ion candidate and a product ion candidate is determined as an MRM transition.

### PRIOR ART DOCUMENTS

### Patent Literature

Patent Literature 1: International Publication No. WO 2017/046867

Patent Literature 2: International Publication No. WO 2009/141852

### SUMMARY OF THE INVENTION

### Problem to be Solved by the Invention

In a mass spectrometer, the measured intensity of ions with a large mass-to-charge ratio (e.g., a mass-to-charge ratio of 1000 or more) is often smaller than that of ions with a small mass-to-charge ratio (e.g., a mass-to-charge ratio of 800 or less). There are multiple factors for this. For example, one factor is that the ion transport optics that transport ions in the mass spectrometer are designed to have high transport efficiency for low mass-to-charge ratio ions. Another factor is, for example, that in a conversion dynode used as a detector in a mass spectrometer, a number of electrons corresponding to the flight speed of the ion is emitted; therefore, the number of electrons generated when a high mass-to-charge ratio ion with a low flight speed enters the conversion dynode is smaller than the number of electrons generated when a low mass-to-charge ratio ion with a high flight speed enters the conversion dynode. Therefore, the measured intensity of ions with a small mass-to-charge ratio becomes large, and precursor ions and product ions with a small mass-to-charge ratio are likely to be determined as an MRM transition.

From compounds with similar structures or properties, precursor ions with similar mass-to-charge ratios are generated, or identical product ions are generated. For example, when the target compound is a peptide, b-series ions are likely to be generated. Also, when the target compound is a nucleic acid, many ions derived from phosphate groups are generated. Therefore, when the target compound is a peptide or a nucleic acid, these ions with a small mass-to-charge ratio are likely to be selected when determining an MRM transition. However, b-series ions with a small mass-to-charge ratio can be generated from many different peptides, and ions derived from phosphate groups with a small mass-to-charge ratio can be generated from many different nucleic acids. As such, ions with a small mass-to-charge ratio are often smaller ions themselves compared to ions with a large mass-to-charge ratio, and thus often do not have a structure characteristic of the target compound. Therefore, if such ions are used for an MRM transition, the compound selectivity of the MRM transition becomes low, and there is a possibility that an interfering compound with a similar structure or properties may be erroneously measured as the target compound.

Although the case of analyzing a target compound by MRM measurement has been described here, a similar problem as described above also existed when analyzing a target compound by performing a SIM measurement of an ion having a specific mass-to-charge ratio generated from the target compound. In particular, since compound selection in a SIM measurement is only a single stage, if the compound selectivity of the target ion used at that time is low, the possibility of erroneously measuring an interfering compound with a similar structure or properties as the target compound is high.

An object of the present invention is to provide a technology capable of accurately analyzing a target compound.

### Means for Solving the Problem

One aspect of a mass spectrometry method according to the present invention, made to solve the above problem, is a mass spectrometry method for determining an MRM transition by:
performing an MS scan measurement of a target compound and selecting one or more precursor ion candidates from among the ions detected in the MS scan measurement based on a predetermined first criterion regarding measured intensity;
performing an MS/MS scan measurement using each of the one or more precursor ion candidates and selecting product ion candidates from among the product ions detected in the MS/MS scan measurement based on a predetermined second criterion regarding measured intensity; and
determining a pair of the precursor ion candidate and the product ion candidate as an MRM transition,
wherein, in the MS scan measurement and/or the MS/MS scan measurement, the mass resolution in a higher mass-to-charge ratio or mass-to-charge ratio range is made lower than the mass resolution in a lower mass-to-charge ratio or mass-to-charge ratio range, in a mode that increases the measurement sensitivity in the higher mass-to-charge ratio or mass-to-charge ratio range.

Another aspect of a mass spectrometry method according to the present invention, made to solve the above problem, is a mass spectrometry method for:
performing an MS scan measurement of a target compound and selecting one or more target ion candidates from among the ions detected in the MS scan measurement based on a predetermined criterion regarding measured intensity,
wherein, in the MS scan measurement, the mass resolution in a higher mass-to-charge ratio or mass-to-charge ratio range is made lower than the mass resolution in a lower mass-to-charge ratio or mass-to-charge ratio range, in a mode that increases the measurement sensitivity in the higher mass-to-charge ratio or mass-to-charge ratio range.

Furthermore, one aspect of a mass spectrometer according to the present invention, made to solve the above problem, comprises:
a precursor ion candidate determination unit that performs an MS scan measurement of a target compound and selects one or more precursor ion candidates from among the ions detected in the MS scan measurement based on a predetermined first criterion regarding measured intensity;
a product ion candidate determination unit that performs an MS/MS scan measurement using each of the one or more precursor ion candidates and selects product ion candidates from among the product ions detected in the MS/MS scan measurement based on a predetermined second criterion regarding measured intensity;
an MRM transition determination unit that determines a pair of the precursor ion candidate and the product ion candidate as an MRM transition; and
a mass resolution setting unit that, in the MS scan measurement and/or the MS/MS scan measurement, makes the mass resolution in a higher mass-to-charge ratio or mass-to-charge ratio range lower than the mass resolution in a lower mass-to-charge ratio or mass-to-charge ratio range, in a mode that increases the measurement sensitivity in the higher mass-to-charge ratio or mass-to-charge ratio range.

Another aspect of a mass spectrometer according to the present invention, made to solve the above problem, comprises:
a target ion determination unit that performs an MS scan measurement of a target compound and determines one or more target ions from among the ions detected in the MS scan measurement based on a predetermined criterion regarding measured intensity; and
a mass resolution setting unit that, in the MS scan measurement, makes the mass resolution in a higher mass-to-charge ratio or mass-to-charge ratio range lower than the mass resolution in a lower mass-to-charge ratio or mass-to-charge ratio range, in a mode that increases the measurement sensitivity in the higher mass-to-charge ratio or mass-to-charge ratio range.

### Effect of the Invention

In the present invention, when performing an MS scan measurement and/or an MS/MS scan measurement, the mass resolution in a higher mass-to-charge ratio or mass-to-charge ratio range is made lower than the mass resolution in a lower mass-to-charge ratio or mass-to-charge ratio range so as to increase the measurement sensitivity in the higher mass-to-charge ratio or mass-to-charge ratio range. While there are various methods to lower the mass resolution, the present invention does not simply lower the mass resolution but lowers the mass resolution in a way that leads to an increase in measurement sensitivity. Therefore, compared to the prior art, ions with a large mass-to-charge ratio are more likely to be selected as an MRM transition or a target ion. Ions with a large mass-to-charge ratio are larger ions themselves compared to ions with a small mass-to-charge ratio and often have a structure characteristic of the target compound. In the present invention, ions with high compound selectivity that have a structure characteristic of the target compound are determined as an MRM transition or a target ion, so even when measuring a sample containing interfering compounds with similar structures and properties along with the target compound, only the target compound can be measured. Therefore, the target compound can be accurately analyzed.

### BRIEF DESCRIPTION OF THE DRAWINGS

FIG. 1 A schematic configuration diagram of a main part of a mass spectrometer according to an embodiment of the present invention.

FIG. 2 A flowchart of an embodiment of a mass spectrometry method according to the present invention for determining an MRM transition using the mass spectrometer of the present embodiment.

FIG. 3 A comparison between an MS spectrum acquired by a conventional MS scan measurement and an MS spectrum acquired by the MS scan measurement in the present embodiment.

FIG. 4 A comparison between an MS/MS spectrum acquired by a conventional MS/MS scan measurement and an MS/MS spectrum acquired by the MS/MS scan measurement in the present embodiment.

FIG. 5 An MS/MS spectrum for explaining an example of not selecting identical or similar ions when selecting product ion candidates.

FIG. 6 A flowchart of a mass spectrometry method of another embodiment for determining a target ion in a SIM measurement.

### DESCRIPTION OF EMBODIMENTS

Embodiments of a mass spectrometry method and a mass spectrometer according to the present invention will be described below with reference to the drawings.

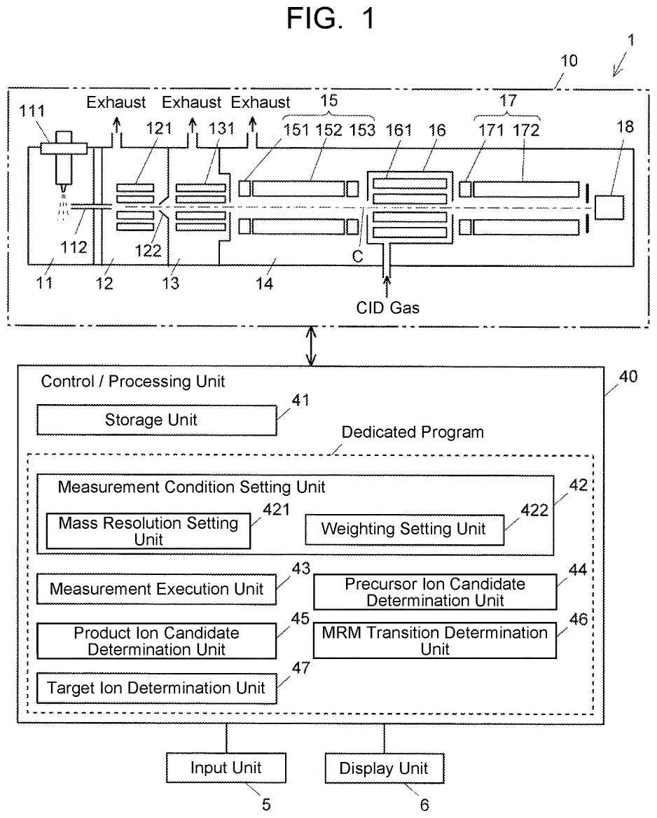

FIG. 1 is a schematic configuration diagram of a main part of a mass spectrometer 1 of the present embodiment. The mass spectrometer of the present embodiment comprises a mass analysis unit 10 and a control/processing unit 40.

The mass analysis unit 10 is provided with an ionization chamber 11 and a vacuum chamber. The vacuum chamber is evacuated by a vacuum pump (not shown). Inside the vacuum chamber, a first intermediate vacuum chamber 12, a second intermediate vacuum chamber 13, and an analysis chamber 14 are provided in this order from the ionization chamber 11 side, having a configuration of a multi-stage differential pumping system in which the degree of vacuum increases in this order.

In the ionization chamber 11, an electrospray ionization (ESI: Electrospray Ionization) probe 111 that charges and sprays a sample solution is installed. A liquid sample can be directly introduced into the ESI probe 111, or a liquid chromatograph can be connected upstream thereof, and sample components separated by the column of the liquid chromatograph can be introduced. The ionization chamber 11 and the subsequent first intermediate vacuum chamber 12 are communicated through a narrow heated capillary 112.

In the first intermediate vacuum chamber 12, an ion guide 121 composed of a plurality of rod electrodes is arranged. The ion guide 121 converges the flight path of ions along an ion optical axis C, which is the central axis of the ion flight path. The first intermediate vacuum chamber 12 and the second intermediate vacuum chamber 13 are separated by a skimmer 122 having a small hole at its apex.

In the second intermediate vacuum chamber 13, an ion guide 131 composed of a plurality of rod electrodes is arranged. The ion guide 131 also converges the flight path of ions along the ion optical axis C, similar to the ion guide 121. The second intermediate vacuum chamber 13 and the analysis chamber 14 are separated by a partition wall in which a small hole is formed.

In the analysis chamber 14, a pre-stage quadrupole mass filter 15, a collision cell 16, a post-stage quadrupole mass filter 17, and an ion detector 18 are arranged. The pre-stage quadrupole mass filter 15 comprises a pre-rod electrode 151, a main rod electrode 152, and a post-rod electrode 153. Inside the collision cell 16, a multipole ion guide 161 is arranged. A collision-induced dissociation (CID: Collision-Induced Dissociation) gas is introduced into the collision cell 16 from a gas source (not shown). The post-stage quadrupole mass filter 17 comprises a pre-rod electrode 171 and a main rod electrode 172.

The mass analysis unit 10 can perform an MS scan measurement, a selected ion monitoring (SIM: Selected Ion Monitoring) measurement, an MS/MS scan (product ion scan) measurement, a multiple reaction monitoring (MRM: Multiple Reaction Monitoring) measurement, etc. In an MS scan measurement, the mass-to-charge ratio of ions passing through the post-stage quadrupole mass filter 17 is scanned, and in a SIM measurement, the mass-to-charge ratio of ions passing through the post-stage quadrupole mass filter 17 is fixed to pass only product ions having a specific mass-to-charge ratio to be detected by the ion detector 18.

In an MS/MS scan measurement and an MRM measurement, both the pre-stage quadrupole mass filter 15 and the post-stage quadrupole mass filter 17 are made to function as mass filters. The pre-stage quadrupole mass filter 15 allows only ions set as precursor ions to pass. A CID gas is supplied into the collision cell 16, and the precursor ions are accelerated by applying energy (collision energy) and introduced therein, and the precursor ions are collided with the CID gas to fragment the precursor ions. In an MS/MS scan measurement, the mass-to-charge ratio of ions passing through the post-stage quadrupole mass filter 17 is scanned, and in an MRM measurement, the mass-to-charge ratio of ions passing through the post-stage quadrupole mass filter 17 is fixed to pass only product ions having a specific mass-to-charge ratio to be detected by the ion detector 18.

The control/processing unit 40 has a storage unit 41. In the storage unit 41, a compound database is stored, which contains information such as measurement conditions and analysis methods for a plurality of known compounds.

The control/processing unit 40 comprises, as functional blocks, a measurement condition setting unit 42, a measurement execution unit 43, a precursor ion candidate determination unit 44, a product ion candidate determination unit 45, an MRM transition determination unit 46, and a target ion determination unit 47. The measurement condition setting unit 42 comprises a mass resolution setting unit 421 and a weighting setting unit 422. The actual entity of the control/processing unit 40 is a personal computer, which is made to function as the above-described respective units by a processor executing a dedicated program pre-installed in the computer. Furthermore, an input unit 5 composed of a mouse, keyboard, or the like, and a display unit 6 composed of a liquid crystal display or the like are connected to the control/processing unit 40.

The mass spectrometer 1 of the present embodiment can be used to analyze (identify or quantify) a target compound contained in a sample by performing a SIM measurement or an MRM measurement of the target compound. If the SIM or MRM measurement conditions for the target compound are recorded in the compound database stored in the storage unit 41, that information is read out to execute the analysis of the target compound. On the other hand, if the measurement conditions for the target compound are not recorded in the compound database, it is first necessary to determine the measurement conditions for the target compound. The mass spectrometer 1 and the mass spectrometry method of the present embodiment are characterized by the process of determining the SIM or MRM measurement conditions for a target compound.

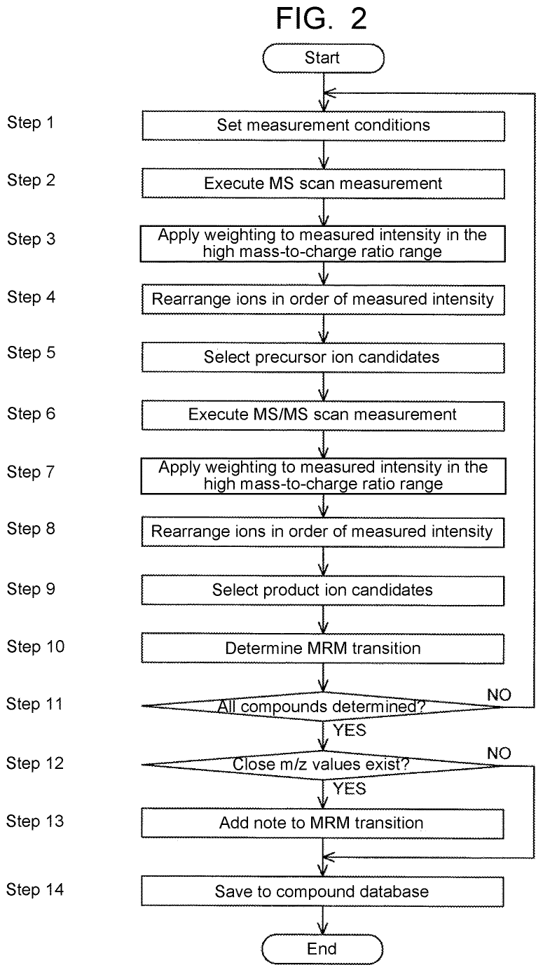

FIG. 2 is a flowchart according to an embodiment of a mass spectrometry method according to the present invention. In the mass spectrometry method of this embodiment, the MRM measurement conditions for a target compound are determined.

When a user performs a predetermined input operation, the measurement condition setting unit 42 prompts the user to input the name of the target compound. Also, it displays on the display unit 6 a screen for selecting whether to change the mass resolution from the normal measurement time when determining the MRM measurement conditions, and whether to apply weighting to ions in a high mass-to-charge ratio range.

When the user selects to change the mass resolution, the mass resolution setting unit 421 prompts the user to input the mass-to-charge ratio range for changing the mass resolution and the mass resolution after the change. In many mass spectrometers, the values and operations of applied voltages to each part are controlled so that the mass resolution in mass analysis becomes high, and for example, the output signal from the ion detector 18 is processed so that the full width at half maximum of a peak in a mass spectrum becomes 0.7. Hereinafter, this mass resolution setting is referred to as “Unit”.

Generally, in a mass spectrometer, the measurement sensitivity of ions with a large mass-to-charge ratio (e.g., a mass-to-charge ratio of 1000 or more) is often about an order of magnitude lower than that of ions with a small mass-to-charge ratio (e.g., a mass-to-charge ratio of 800 or less). There are multiple factors for this. For example, one factor is that the ion transport optics that transport ions in the mass spectrometer, such as the ion guides 121 and 131, are designed to have high transport efficiency for low mass-to-charge ratio ions. Also, in a conversion dynode, which is widely used as an ion detector, a number of electrons corresponding to the flight speed of the ion is emitted; therefore, another factor is that the number of electrons generated when a high mass-to-charge ratio ion with a low flight speed enters the conversion dynode is smaller than the number of electrons generated when a low mass-to-charge ratio ion with a high flight speed enters the conversion dynode.

In the present embodiment, in consideration of the above points, the measurement conditions are determined so that the measured intensity in the high mass-to-charge ratio range becomes equal to or greater than the measured intensity in the low mass-to-charge ratio range. Here, the mass resolution in the low mass-to-charge ratio range (a range where m/z is less than 1000) is set to the above-mentioned Unit, and in the high mass-to-charge ratio range (a range where m/z is 1000 or more), the mass resolution is set so that the output signal from the ion detector 18 is processed such that the full width at half maximum of a peak in a mass spectrum becomes 3.0. Hereinafter, the latter mass resolution setting is referred to as “Low”.

If the user has selected to apply weighting to the high mass-to-charge ratio range, the weighting setting unit 422 subsequently prompts the user to input the mass-to-charge ratio range for setting the weighting and the content of the weighting. The mass-to-charge ratio range for setting the weighting may typically be the same as the mass range in which the measurement sensitivity was increased by lowering the mass resolution, but it may also be a different mass-to-charge ratio range. The content of the weighting can be, for example, multiplying the measured intensity by a constant coefficient, or multiplying by a coefficient calculated by a function with the value of the mass-to-charge ratio as a variable, and so on. Hereinafter, a case will be described where it is set to multiply the measured intensity by a constant coefficient k (k>1, for example, k=2).

When the setting of the mass resolution and the weighting is completed, the measurement condition setting unit 42 subsequently prompts the user to input the mass scan range in the MS scan measurement, and the mass scan range and the collision energy (CE: Collision Energy) value in the MS/MS scan measurement. The CE is the magnitude of energy imparted to a precursor ion when dissociating the precursor ion. Here, as an example, 11 measurement conditions are set, changing in 5V increments within a range of 5V to 50V. Also, the mass scan range in each of the MS scan measurement and the MS/MS scan measurement is set to 0 to 2000.

When the user sets the above respective measurement conditions (Step 1) and the user instructs to start the measurement, the measurement execution unit 43 prompts the user to introduce a liquid sample containing a predetermined amount of the target compound into the ESI probe 111. When the user introduces the liquid sample into the ESI probe 111, the measurement execution unit 43 executes an MS scan measurement in the mass scan range set as the said measurement condition (Step 2). The detection signals of ions that entered the ion detector 18 during the measurement are sequentially transmitted to the control/processing unit 40 and stored in the storage unit 41.

When the MS scan measurement is completed, the measurement execution unit 43 reads out the output signal from the ion detector 18 stored in the storage unit 41. Then, it sets a mass window of Unit, that is, a mass window where the full width at half maximum of a mass peak is 0.7, for the detection intensity in the range where the mass-to-charge ratio is less than 1000 (low mass-to-charge ratio range), and sets a mass window of Low, that is, a mass window where the full width at half maximum of a mass peak is 3.0, for the detection signal in the range where the mass-to-charge ratio is 1000 or more (high mass-to-charge ratio range), and sums up the detection signals within the range of each mass window.

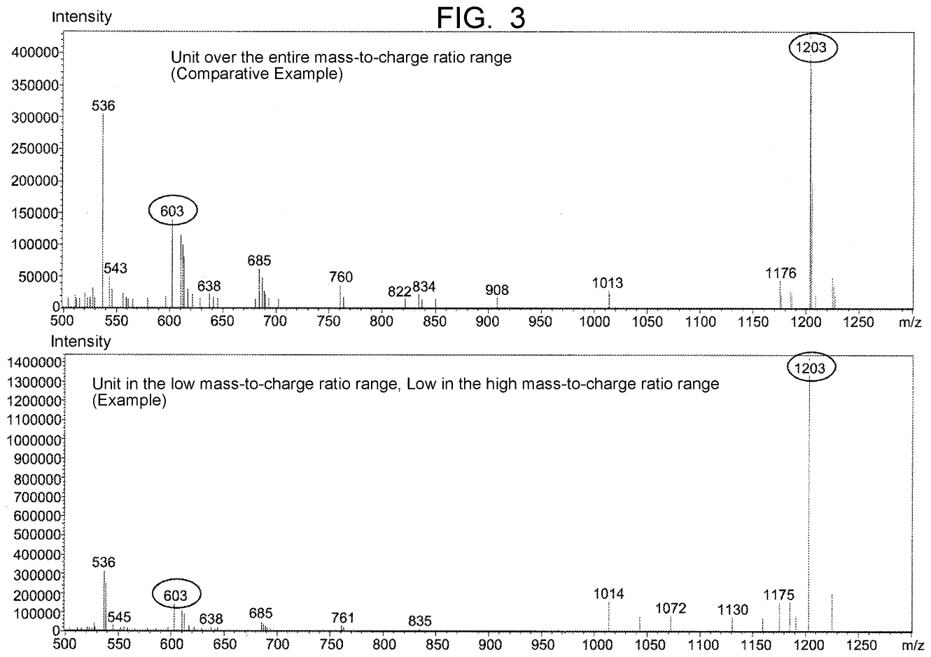

The effect of performing such processing will be described with reference to FIG. 3. FIG. 3 is an example of an MS spectrum obtained by an MS scan measurement. The upper part is an MS spectrum (comparative example) obtained when a Unit mass window is set over the entire mass scan range, and the lower part is an MS spectrum (example) created by setting a Unit mass window in the low mass-to-charge ratio range and a Low mass window in the high mass-to-charge ratio range as in the present embodiment. Note that the upper and lower MS spectra of FIG. 3 are extractions of the portion where the mass-to-charge ratio is 500 to 1300 of the mass scan range.

In the Unit mass window, isotope ions are separated and their measured intensities are calculated individually, whereas in the Low mass window, the detection intensities of isotope ions differing by about 1 in mass-to-charge ratio are summed. For example, in the MS spectrum (Unit) in the upper part of FIG. 3, a mass peak of an isotope ion appears adjacent to the mass peak of an ion with a mass-to-charge ratio of 1203, but in the MS spectrum (Low) in the lower part, these have become a single mass peak. Focusing on the mass peak of the ion with a mass-to-charge ratio of 603 and the mass peak of the ion with a mass-to-charge ratio of 1203, while the peak intensity of the former is about 150000 in both the upper and lower MS spectra, it can be seen that the peak intensity of the latter has increased by about 3.3 times, from about 430000 in the upper MS spectrum to about 1400000.

The precursor ion candidate determination unit 44 extracts the mass peaks appearing in the MS spectrum created by the measurement execution unit 43 (the MS spectrum in the lower part of FIG. 3), and creates a peak list associating their mass-to-charge ratios with their measured intensities. Also, after multiplying the measured intensity of the mass peaks in the high mass-to-charge ratio range by the weighting coefficient k preset by the user (Step 3), it arranges each mass peak in order of measured intensity (Step 4). Then, in each of the high mass-to-charge ratio range and the low mass-to-charge ratio range, it individually extracts a predetermined number of mass peaks in descending order of measured intensity (for example, 2 for the high mass-to-charge ratio range and 1 for the low mass-to-charge ratio range), and selects the ions with mass-to-charge ratios corresponding to the mass peaks as precursor ion candidates (Step 5). By extracting mass peaks in this way, at least the above-mentioned predetermined number of mass peaks can be extracted from the high mass-to-charge ratio range to select precursor ion candidates. Alternatively, in Step 5, a predetermined number of mass peaks (e.g., 3) may be extracted in descending order of measured intensity after weighting, over the entire mass-to-charge ratio range, to select precursor ion candidates.

However, even for a mass peak with high measured intensity, if the difference in mass-to-charge ratio from the mass peak of an ion already selected as a precursor ion candidate is smaller than a predetermined value, it is excluded. Specifically, for example, an ion within a range of ±5 in mass-to-charge ratio centered on the mass-to-charge ratio of an ion already selected as a precursor ion candidate is not selected as a precursor ion candidate even if it is a mass peak with high measured intensity. This makes it possible to avoid selecting multiple isotope ions, which have substantially the same structure, as precursor ion candidates. Although a predetermined number of mass peaks were extracted here in descending order of measured intensity, a configuration can also be adopted in which all mass peaks with measured intensity exceeding a predetermined threshold are extracted, or a predetermined number are extracted in descending order of mass-to-charge ratio from among the mass peaks with measured intensity exceeding a predetermined threshold.

In Step 5, the larger the weighting coefficient k, the more likely ions in the high mass-to-charge ratio range are to be selected as precursor ion candidates. Therefore, the weighting coefficient k should be set in advance according to how much emphasis is placed on high mass-to-charge ratio ions as precursor ion candidates. Alternatively, after confirming the mass spectrum obtained by the measurement, the user may set or change the weighting coefficient k. Although the weighting coefficient k is set in this embodiment, as described above, since the measurement sensitivity of high mass-to-charge ratio ions has already been increased by the process of lowering the mass resolution, if it is not necessary to increase the measured intensity any further, weighting may not be performed when setting the measurement conditions. Also, ions that are foreseen to be generated from compounds other than the target compound contained in the liquid sample (solvent, mobile phase, etc.) may be set as exclusion ions in advance, and in Step 5, ions that are the same as or have a mass-to-charge ratio close to the exclusion ions may be excluded from the selection targets. This is also the same in the MS/MS scan measurement described later.

When precursor ion candidates are selected in Step 5, the measurement execution unit 43 executes an MS/MS scan measurement for each of the precursor ion candidates under the previously set measurement conditions (11 measurement conditions with different CE values) (Step 6). When the user introduces the liquid sample into the ESI probe 111, the measurement execution unit 43 sequentially executes 33 MS/MS scan measurements, that is, for each of the 3 precursor ion candidates under 11 different measurement conditions (Step 6). The detection signals of ions that entered the ion detector 18 during the measurement are sequentially transmitted to the control/processing unit 40 and stored in the storage unit 41.

When the MS/MS scan measurement is completed, the measurement execution unit 43 reads out the output signal from the ion detector 18 stored in the storage unit 41. Then, for the detection intensity in the range where the mass-to-charge ratio is less than 1000 (low mass-to-charge ratio range), it sets a mass window of Unit, that is, a mass window where the full width at half maximum of a mass peak is 0.7, and for the detection signal in the range where the mass-to-charge ratio is 1000 or more (high mass-to-charge ratio range), it sets a mass window of Low, that is, a mass window where the full width at half maximum of a mass peak is 3.0, and executes a process of summing the detection signals within the range of each mass window.

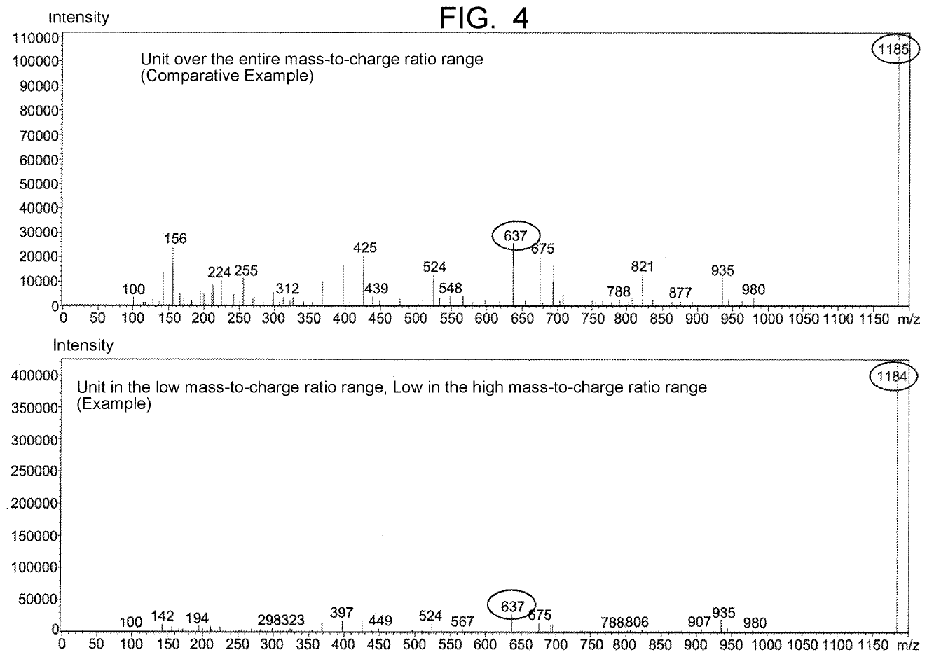

FIG. 4 shows an example of an MS/MS spectrum (product ion spectrum) obtained by an MS/MS scan measurement. The upper part is an MS spectrum (comparative example) obtained when a Unit mass window is set over the entire mass scan range, and the lower part is an MS spectrum (example) created by setting a Unit mass window in the low mass-to-charge ratio range and a Low mass window in the high mass-to-charge ratio range as in the present embodiment. Note that the upper and lower MS/MS spectra of FIG. 4 are extractions of the portion where the mass-to-charge ratio is 0 to 1200 of the mass scan range.

As also explained with the MS spectrum of FIG. 3, in the Unit mass window, isotope ions are separated and their measured intensities are calculated individually, whereas in the Low mass window, the detection intensities of isotope ions differing by about 1 in mass-to-charge ratio are summed. Focusing on the mass peak of the ion with a mass-to-charge ratio of 637 and the mass peak of the ion with a mass-to-charge ratio of 1185 (1184 in the lower part), while the peak intensity of the former is about 28000 in both the upper and lower MS spectra, it can be seen that the peak intensity of the latter has increased by about 3.7 times, from about 110000 in the upper MS spectrum to about 410000.

The product ion candidate determination unit 45 extracts the mass peaks appearing in each of the 33 MS/MS spectra created by the measurement execution unit 43 (MS/MS spectra acquired for each of the three precursor ion candidates under 11 different measurement conditions, an example of which is the MS/MS spectrum in the lower part of FIG. 4), and creates a peak list associating their mass-to-charge ratios with their measured intensities. Also, after multiplying the measured intensity of the mass peaks in the high mass-to-charge ratio range by the weighting coefficient k preset by the user (Step 7), it arranges each mass peak in order of measured intensity (Step 8). Then, in each of the high mass-to-charge ratio range and the low mass-to-charge ratio range, it individually extracts a predetermined number of mass peaks in descending order of measured intensity (for example, 3 for the high mass-to-charge ratio range and 2 for the low mass-to-charge ratio range), and selects the ions with mass-to-charge ratios corresponding to the mass peaks as product ion candidates (Step 9). By extracting mass peaks in this way, at least the above-mentioned predetermined number of mass peaks can be extracted from the high mass-to-charge ratio range to select product ion candidates. Alternatively, in Step 9, a predetermined number of mass peaks (e.g., 3) may be extracted in descending order of measured intensity after weighting, over the entire mass-to-charge ratio range, to select product ion candidates.

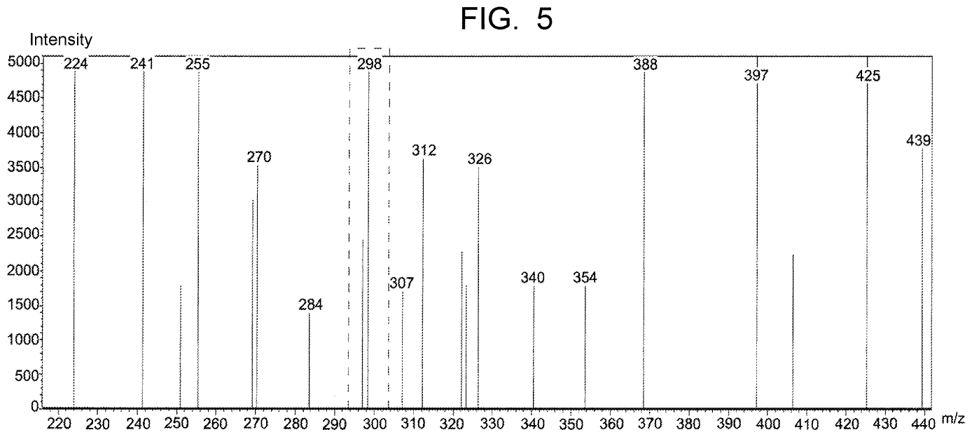

An example of not selecting ions with close mass-to-charge ratios as precursor ion candidates or product ion candidates in Step 5 and Step 9 is shown in FIG. 5. FIG. 5 is an example of a product ion spectrum acquired by an MS/MS scan measurement.

FIG. 5 shows an extraction of the product ion spectrum in the mass-to-charge ratio range of 215 to 440, where high-intensity mass peaks appear at mass-to-charge ratios of 224, 241, 255, 298, 388, 397, 425, and 439. When setting these mass peaks as product ion candidates, ions whose difference in mass-to-charge ratio from the said ion is within a predetermined range (for example, within a range of ±5) are excluded from the targets for product ion candidates. For example, for the mass peak with a mass-to-charge ratio of 298, ions having a mass-to-charge ratio within the range enclosed by the dashed line are excluded. As a result, the mass peak appearing on the low mass-to-charge ratio side of the mass peak with a mass-to-charge ratio of 298, although having a relatively high intensity, is excluded from the targets for product ion candidates. A mass peak appearing in the vicinity of a high-intensity mass peak is often a peak of an isotope ion. Even if such an isotope ion's mass peak is selected as a product ion candidate, it has only the same compound selectivity as the already selected product ion candidate with a mass-to-charge ratio of 298, so by excluding such isotope ions, the compound selectivity of the finally determined MRM transition can be enhanced. FIG. 5 is an example concerning the selection of product ion candidates, but the same applies to the selection of precursor ion candidates.

When determining an MRM transition, it is necessary to perform an MS/MS scan measurement for each of a plurality of precursor ion candidates selected based on the results of the MS scan measurement, under measurement conditions associated with a plurality of different CE values. In the case of the present embodiment, an MS/MS scan measurement is performed using each of 33 different measurement conditions. If the mass scan range is wide, or if the CE values are set more finely, the time required for a series of measurements becomes even longer. To execute such measurements in a limited time, it is necessary to increase the mass scanning speed in the MS/MS scan measurement. However, increasing the mass scanning speed may cause a mass shift in the MS/MS spectrum. As a result, in different MS/MS scan measurements, the same product ion may be measured as an ion with a slightly different mass-to-charge ratio (for example, differing by ±1). For example, if product ions with mass-to-charge ratios of 99, 100, and 101 are measured with high intensity, and all three of these product ions are selected, three MRM transitions containing the same product ion will ultimately be determined. However, the compound selectivity possessed by these three ions is the same, and using MRM transitions each containing one of these three product ions has no effect on enhancing compound selectivity. In the present embodiment, by excluding ions within a predetermined range of mass-to-charge ratio centered on the mass-to-charge ratio of an already selected product ion candidate, it is also possible to avoid selecting the same product ion multiple times.

When product ion candidates are selected in Step 9, the MRM transition determination unit 46 determines as an MRM transition a pairing of each product ion candidate and the precursor ion candidate that generated the said product ion candidate (Step 10).

When an MRM transition is determined for one of the target compounds, the measurement execution unit 43 confirms whether MRM transitions have been determined for all target compounds. If there is a target compound for which an MRM transition has not yet been determined (NO at Step 11), the same steps as above are sequentially executed for the next target compound to determine an MRM transition. The measurement conditions for the target compound set in Step 1 may be common to all compounds, or may be different for each compound.

When MRM transitions have been determined for all target compounds (YES at Step 11), the MRM transition determination unit 46 refers to the mass-to-charge ratios of the precursor and product ions included in the MRM transition determined for each compound, and determines the presence or absence of those whose values are close (e.g., the difference in mass-to-charge ratio is within ±5). If there is a target compound for which an MRM transition with a close precursor ion and/or product ion has been determined (YES at Step 12), a note is attached to the said MRM transition (Step 13). Specifically, it is noted that “the mass-to-charge ratio of the precursor or product ion is similar to that of compound A (compound name)”. This makes it possible to avoid misidentification or errors in quantitative values when the user analyzes a sample that may contain both the said target compound and another compound, by using an MRM transition with low selectivity for these compounds. After the series of steps described above, the MRM transition determination unit 46 stores the MRM transition determined for each target compound in the compound database of the storage unit 41 (Step 14). If NO at Step 12, the MRM transition determined in Step 11 is stored as is in the compound database (Step 14).

In the above, those with close mass-to-charge ratios among the MRM transitions determined in the current measurement were extracted, but furthermore, it may be configured to check whether there are any with close mass-to-charge ratios (for example, a difference in mass-to-charge ratio within ±5) with the MRM transitions of each compound recorded in the compound database and attach a note. In that case, it is advisable to attach a similar note to the MRM transitions already stored in the compound database as well.

As described above, in a mass spectrometer, the measured intensity of ions with a large mass-to-charge ratio (e.g., a mass-to-charge ratio of 1000 or more) is often smaller than that of ions with a small mass-to-charge ratio (e.g., a mass-to-charge ratio of 800 or less). Therefore, if an MS scan measurement or an MS/MS scan measurement is performed with the same mass resolution over the entire mass scan range, the measured intensity of ions with a small mass-to-charge ratio becomes large, and precursor ions and product ions with a small mass-to-charge ratio are likely to be determined as an MRM transition.

From compounds with similar structures or properties, precursor ions with similar mass-to-charge ratios are generated, or identical product ions are generated. For example, when the target compound is a peptide, b-series ions are likely to be generated. Also, when the target compound is a nucleic acid, many ions derived from phosphate groups are generated. Therefore, when the target compound is a peptide or a nucleic acid, these ions with a small mass-to-charge ratio are likely to be selected when determining an MRM transition. However, b-series ions with a small mass-to-charge ratio can be generated from many different peptides, and ions derived from phosphate groups with a small mass-to-charge ratio can be generated from many different nucleic acids. As such, ions with a small mass-to-charge ratio are often smaller ions themselves compared to ions with a large mass-to-charge ratio, and thus often do not have a structure characteristic of the target compound. Therefore, if such ions are used for an MRM transition, the compound selectivity of the MRM transition becomes low, and there is a possibility that an interfering compound with a similar structure or properties may be erroneously measured as the target compound. Also, in the low mass-to-charge ratio range, ions derived from the mobile phase are likely to be detected, and noise originating from the instrument is likely to be superimposed. Therefore, there was a problem that it was difficult to accurately analyze the target compound.

In contrast, in the present embodiment, the measurement sensitivity in the high mass-to-charge ratio range is increased by making the mass window in the high mass-to-charge ratio range wider than the mass window in the low mass-to-charge ratio range. Therefore, compared to the prior art, ions with a large mass-to-charge ratio are more likely to be selected as an MRM transition. Ions with a large mass-to-charge ratio are larger ions themselves compared to ions with a small mass-to-charge ratio and often have a structure characteristic of the target compound. In the present embodiment, ions with high compound selectivity that have a structure characteristic of the target compound are determined as an MRM transition, so even when measuring a sample containing interfering compounds with similar structures and properties along with the target compound, only the target compound can be measured.

Also, by determining ions with a large mass-to-charge ratio as an MRM transition, the influence of ions derived from the mobile phase and noise in MRM or SIM measurements is reduced. Therefore, the target compound can be analyzed more accurately compared to the prior art.

Furthermore, in the low mass-to-charge ratio range, ions derived from the mobile phase are likely to be detected, and noise originating from the instrument is likely to be superimposed. In contrast, in the high mass-to-charge ratio range, noise is intermittent, and its intensity is also small. Therefore, by setting to “Low” (widening the mass window) in the high mass-to-charge ratio range, the S/N ratio can be increased, and a high-quality mass spectrum can be obtained.

Although an example of determining an MRM transition has been described above, a target ion in a SIM measurement can also be determined by following similar steps. In this case, as functional blocks, a target ion determination unit 47 is used in place of the precursor ion candidate determination unit 44 and the product ion candidate determination unit 45.

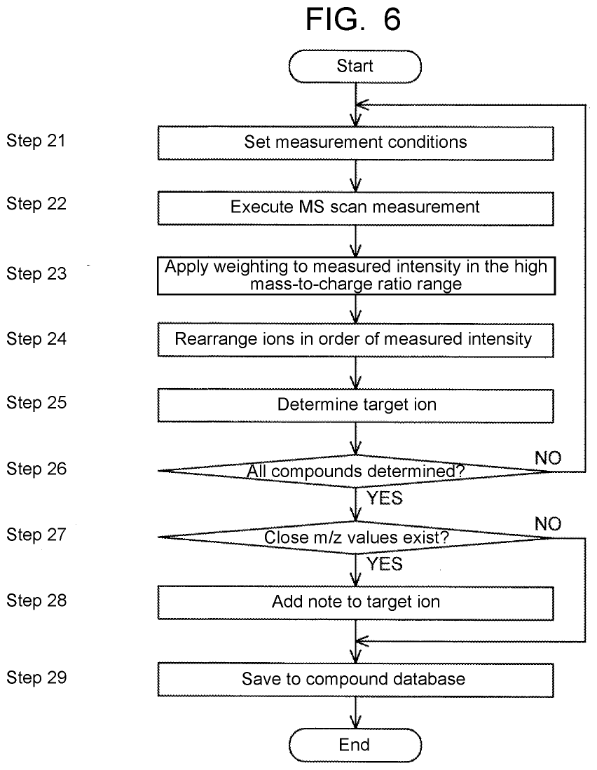

FIG. 6 is a flowchart for determining a target ion in a SIM measurement. As can be understood from the comparison with FIG. 2, by executing Steps 21 to 25, which respectively correspond to Steps 1 to 5 executed when determining an MRM transition, a target ion in a SIM measurement can be determined. Also, when determining a target ion, similarly to the above, after determining the target ions for all target compounds (YES at Step 26), if there are target ions with close mass-to-charge ratios between different target compounds (YES at Step 27), a note is attached to the said target ion (Step 28), and then it is stored in the compound database (Step 29).

The above embodiment is an example, and can be appropriately modified in line with the spirit of the present invention.

In the above embodiment, the measurement sensitivity in the high mass-to-charge ratio range was increased by making the mass window in the high mass-to-charge ratio range wider than the mass window in the low mass-to-charge ratio range, but any method that increases the measurement sensitivity in the high mass-to-charge ratio range may be used, and a method different from the above embodiment can also be used.

For example, in a mass spectrometer that uses a quadrupole mass filter for ion mass separation as in the above embodiment, a DC voltage and a radio frequency voltage tuned to achieve high mass resolution are normally applied to each rod electrode. As described in Patent Literature 2, for example, a stability diagram is known as a solution to the Mathieu equation that describes the behavior of ions in a quadrupole electric field, and the closer a point corresponding to the DC voltage and radio frequency voltage applied to each rod electrode is to the periphery of the approximately triangular stable region shown in the stability diagram, the higher the mass resolution obtained. Here, if a DC voltage and a radio frequency voltage corresponding to a point located inside the periphery of the stable region are applied, the mass separation capability in the quadrupole mass filter decreases and the mass resolution decreases, but the ion transmission rate improves and the measurement sensitivity increases. Therefore, in place of the detection signal processing in the above embodiment, by applying a DC voltage and a radio frequency voltage to each rod electrode corresponding to a point located inside the point generally used in a quadrupole mass filter in the said stable region, the measurement sensitivity of ions in the high mass-to-charge ratio range can be similarly increased as described above.

In the above embodiment, two mass-to-charge ratio ranges were set: a low mass-to-charge ratio range where the mass-to-charge ratio is less than 1000, and a high mass-to-charge ratio range where the mass-to-charge ratio is 1000 or more, but the boundary between the low mass-to-charge ratio range and the high mass-to-charge ratio range can be appropriately changed. Considering the characteristics of the mass spectrometer described in the above embodiment, it is preferable to set this boundary to a value of 800 or more and 1000 or less. Also, in the above embodiment, two ranges, a low mass-to-charge ratio range and a high mass-to-charge ratio range, were set, and for the latter, the mass resolution was lowered to increase the measurement sensitivity and weighting was applied to the measured intensity, but three or more mass-to-charge ratio ranges (for example, three ranges: less than 1000, 1000 or more and less than 1500, and 1500 or more) may be set, and different mass resolutions or weightings may be set for each of the plurality of mass-to-charge ratio ranges located on the high mass-to-charge ratio side.

In the above embodiment, the mass resolution and weighting were set for each mass-to-charge ratio range, but these may also be set for each mass-to-charge ratio. For example, by setting the width of the mass window used when lowering the mass resolution and/or the weighting coefficient as a function of the mass-to-charge ratio, the values of the mass resolution and weighting can be changed continuously.

In the above embodiment, the setting of mass resolution and the setting of weighting in the MS scan measurement and the MS/MS scan measurement for determining the MRM measurement conditions were made the same, but the respective settings for the MS scan measurement and the MS/MS scan measurement may be different. Also, in the above embodiment, in both the MS scan measurement and the MS/MS scan measurement for determining the MRM measurement conditions, the mass resolution in the high mass-to-charge ratio range was lowered to increase the measurement sensitivity, and weighting was also set, but the mass resolution in the high mass-to-charge ratio range may be changed or weighting may be set for only one of the MS scan measurement and the MS/MS scan measurement.

In the above embodiment, the mass resolution was lowered and the measurement sensitivity was increased in the high mass-to-charge ratio range by setting the measurement conditions related to the processing of the measurement signal obtained from the ion detector 18 to Unit and Low in the low mass-to-charge ratio range and the high mass-to-charge ratio range, respectively, but the mass resolution can also be lowered and the measurement sensitivity increased by using other measurement conditions.

In the above embodiment, when selecting precursor ion candidates or product ion candidates, those whose difference from the mass-to-charge ratio of an already selected ion is ±5 or less were not selected, but this value can be appropriately changed (for example, a value in the range of ±1 to 10) according to the properties of the target compound. For example, when the target compound is a peptide, by setting this value to a value of about ±100 to 150 (for example, ±120), that is, a value equivalent to the mass number of one base, it is possible to avoid selecting multiple ions with the same number of bases as precursor ion candidates or product ion candidates.

In the above embodiment, a triple quadrupole type mass spectrometer equipped with an ESI probe as an ion source for ionizing a liquid sample and with quadrupole mass filters before and after a collision cell has been described, but an ion source suitable for the properties of the sample may be used, and various types of mass separation units, such as an ion trap, a time-of-flight mass filter, etc., can also be used.

### ASPECTS

It is apparent to those skilled in the art that the exemplary embodiments described above are specific examples of the following aspects.

### Item 1

A mass spectrometry method according to one aspect of the present invention is a mass spectrometry method for determining an MRM transition by:
performing an MS scan measurement of a target compound and selecting one or more precursor ion candidates from among the ions detected in the MS scan measurement based on a predetermined first criterion regarding measured intensity,
performing an MS/MS scan measurement using each of the one or more precursor ion candidates and selecting product ion candidates from among the product ions detected in the MS/MS scan measurement based on a predetermined second criterion regarding measured intensity, and
determining a pair of the precursor ion candidate and the product ion candidate as an MRM transition,
wherein, in the MS scan measurement and/or the MS/MS scan measurement, the mass resolution in a higher mass-to-charge ratio or mass-to-charge ratio range is made lower than the mass resolution in a lower mass-to-charge ratio or mass-to-charge ratio range, in a mode that increases the measurement sensitivity in the higher mass-to-charge ratio or mass-to-charge ratio range.

### Item 7

A mass spectrometry method according to another aspect of the present invention is a mass spectrometry method for selecting one or more target ion candidates from among ions detected in an MS scan measurement of a target compound based on a predetermined criterion regarding measured intensity,
wherein, in the MS scan measurement, the mass resolution in a higher mass-to-charge ratio or mass-to-charge ratio range is made lower than the mass resolution in a lower mass-to-charge ratio or mass-to-charge ratio range, in a mode that increases the measurement sensitivity in the higher mass-to-charge ratio or mass-to-charge ratio range.

### Item 8

A mass spectrometer according to one aspect of the present invention comprises:
a precursor ion candidate determination unit that performs an MS scan measurement of a target compound and selects one or more precursor ion candidates from among the ions detected in the MS scan measurement based on a predetermined first criterion regarding measured intensity;
a product ion candidate determination unit that performs an MS/MS scan measurement using each of the one or more precursor ion candidates and selects product ion candidates from among the product ions detected in the MS/MS scan measurement based on a predetermined second criterion regarding measured intensity;
an MRM transition determination unit that determines a pair of the precursor ion candidate and the product ion candidate as an MRM transition; and
a mass resolution setting unit that, in the MS scan measurement and/or the MS/MS scan measurement, makes the mass resolution in a higher mass-to-charge ratio or mass-to-charge ratio range lower than the mass resolution in a lower mass-to-charge ratio or mass-to-charge ratio range, in a mode that increases the measurement sensitivity in the higher mass-to-charge ratio or mass-to-charge ratio range.

### Item 9

A mass spectrometer according to another aspect of the present invention comprises:
a target ion determination unit that performs an MS scan measurement of a target compound and determines one or more target ions from among the ions detected in the MS scan measurement based on a predetermined criterion regarding measured intensity; and
a mass resolution setting unit that, in the MS scan measurement, makes the mass resolution in a higher mass-to-charge ratio or mass-to-charge ratio range lower than the mass resolution in a lower mass-to-charge ratio or mass-to-charge ratio range, in a mode that increases the measurement sensitivity in the higher mass-to-charge ratio or mass-to-charge ratio range.

In the mass spectrometry method according to Items 1 and 7, and the mass spectrometer according to Items 8 and 9, when performing an MS scan measurement and/or an MS/MS scan measurement, the mass resolution in a higher mass-to-charge ratio or mass-to-charge ratio range is made lower than the mass resolution in a lower mass-to-charge ratio or mass-to-charge ratio range, in a mode that increases the measurement sensitivity in the higher mass-to-charge ratio or mass-to-charge ratio range. While there are various methods to lower the mass resolution, in the mass spectrometry method according to Items 1 and 7, and the mass spectrometer according to Items 8 and 9, the mass resolution is not simply lowered, but is lowered in a mode that leads to an increase in measurement sensitivity. Therefore, compared to the prior art, ions with a large mass-to-charge ratio are more likely to be selected as an MRM transition or a target ion. Ions with a large mass-to-charge ratio are larger ions themselves compared to ions with a small mass-to-charge ratio and often have a structure characteristic of the target compound.

In the mass spectrometry method according to Items 1 and 7, and the mass spectrometer according to Items 8 and 9, ions with high compound selectivity that have a structure characteristic of the target compound are determined as an MRM transition or a target ion, so even when measuring a sample containing interfering compounds with similar structures and properties along with the target compound, only the target compound can be measured. Also, by determining ions with a large mass-to-charge ratio as an MRM transition or a target ion, the influence of ions derived from the mobile phase and noise in MRM or SIM measurements is reduced. Therefore, the target compound can be accurately analyzed. Note that the first criterion and the second criterion in the present invention may be the same or different.

### Item 2

The mass spectrometry method according to Item 1, wherein, in the MS scan measurement and/or the MS/MS scan measurement, after multiplying the measured intensity of each ion in the higher mass-to-charge ratio or mass-to-charge ratio range by a predetermined coefficient greater than 1, a predetermined number of ions are determined as the precursor ion candidates and/or the product ion candidates in descending order of measured intensity.

In the mass spectrometry method according to Item 2, by appropriately setting the said predetermined coefficient, it is possible to make it easier to preferentially select ions with a large mass-to-charge ratio as precursor ion candidates or product ion candidates.

### Item 3

The mass spectrometry method according to Item 1 or 2, wherein the mass resolution is lowered by making a mass window, which is a range for summing measured intensities, wider in the higher mass-to-charge ratio or mass-to-charge ratio range than in the lower mass-to-charge ratio or mass-to-charge ratio range.

### Item 4

The mass spectrometry method according to any one of Items 1 to 3, wherein the mass resolution is lowered by lowering a mass separation capability in a mass separation unit that mass-separates ions to increase an ion transmission rate in the higher mass-to-charge ratio or mass-to-charge ratio range.

As a method for making the mass resolution in a higher mass-to-charge ratio or mass-to-charge ratio range lower than the mass resolution in a lower mass-to-charge ratio or mass-to-charge ratio range, in a mode that increases the measurement sensitivity in the higher mass-to-charge ratio or mass-to-charge ratio range, for example, a method of making a mass window, which is a range for summing measured intensities, wider in the higher mass-to-charge ratio or mass-to-charge ratio range than in the lower mass-to-charge ratio or mass-to-charge ratio range, as described in Item 3, or a method of lowering a mass separation capability in a mass separation unit that mass-separates ions to increase an ion transmission rate in the higher mass-to-charge ratio or mass-to-charge ratio range, as described in Item 4, can be used.

### Item 5

The mass spectrometry method according to any one of Items 1 to 4, wherein, when selecting the precursor ion candidates and/or the product ion candidates, an ion whose difference from a mass-to-charge ratio of a previously selected ion is within a predetermined range is excluded, and another candidate is selected.

In the mass spectrometry method according to Item 5, it is possible to avoid the duplicate selection of the same ion or ions with similar structures as multiple precursor ion candidates or product ion candidates, and to determine an MRM transition with higher compound selectivity.

### Item 6

The mass spectrometry method according to any one of Items 1 to 5, wherein an MRM transition is determined for each of a plurality of target compounds, and further, for an MRM transition including a precursor ion candidate and/or a product ion candidate with a close mass-to-charge ratio between different compounds, it is noted that the mass-to-charge ratio is close to that of an MRM transition of another compound.

In the mass spectrometry method according to Item 6, when analyzing a sample containing a plurality of compounds for which the mass-to-charge ratio of a precursor ion and/or a product ion included in an MRM transition is close, the said note serves as a warning that the said MRM transition has low selectivity for the said plurality of compounds, thereby making it possible to avoid misidentifying these compounds or causing errors in quantitative values.

### REFERENCE SIGNS LIST

1 . . . Mass spectrometer
10 . . . Mass analysis unit
11 . . . Ionization chamber
111 . . . ESI probe
12 . . . First intermediate vacuum chamber
121 . . . Ion guide
122 . . . Skimmer
13 . . . Second intermediate vacuum chamber
131 . . . Ion guide
14 . . . Analysis chamber
15 . . . Pre-stage quadrupole mass filter
151 . . . Pre-rod electrode
152 . . . Main rod electrode
153 . . . Post-rod electrode
16 . . . Collision cell
161 . . . Multipole ion guide
17 . . . Post-stage quadrupole mass filter
171 . . . Pre-rod electrode
172 . . . Main rod electrode
18 . . . Ion detector
40 . . . Control/processing unit
41 . . . Storage unit
42 . . . Measurement condition setting unit
421 . . . Mass resolution setting unit
422 . . . Weighting setting unit
43 . . . Measurement execution unit
44 . . . Precursor ion candidate determination unit
45 . . . Product ion candidate determination unit
46 . . . MRM transition determination unit
47 . . . Target ion determination unit
5 . . . Input unit
6 . . . Display unit
C . . . Ion optical axis

1. A mass spectrometry method, comprising:
performing a MS scan measurement of a target compound, and selecting one or more precursor ion candidates from among ions detected in the MS scan measurement based on a predetermined first criterion regarding measured intensity;
performing a MS/MS scan measurement using each of the one or more precursor ion candidates, and selecting product ion candidates from among product ions detected in the MS/MS scan measurement based on a predetermined second criterion regarding measured intensity; and
determining a pair of the precursor ion candidate and the product ion candidate as an MRM transition,
wherein, in the MS scan measurement and/or the MS/MS scan measurement, a mass resolution in a higher mass-to-charge ratio or mass-to-charge ratio range is made lower than a mass resolution in a lower mass-to-charge ratio or mass-to-charge ratio range, in a mode that increases a measurement sensitivity in the higher mass-to-charge ratio or mass-to-charge ratio range.

2. The mass spectrometry method according to claim 1, wherein, in the MS scan measurement and/or the MS/MS scan measurement, after multiplying a measured intensity of each ion in the higher mass-to-charge ratio or mass-to-charge ratio range by a predetermined coefficient greater than 1, a predetermined number of ions are determined as the precursor ion candidates and/or the product ion candidates in descending order of measured intensity.

3. The mass spectrometry method according to claim 1, wherein the mass resolution is lowered by making a mass window, which is a range for summing measured intensities, wider in the higher mass-to-charge ratio or mass-to-charge ratio range than in the lower mass-to-charge ratio or mass-to-charge ratio range.

4. The mass spectrometry method according to claim 1, wherein the mass resolution is lowered by lowering a mass separation capability in a mass separation unit that mass-separates ions to increase an ion transmission rate in the higher mass-to-charge ratio or mass-to-charge ratio range.

5. The mass spectrometry method according to claim 1, wherein, when selecting the precursor ion candidates and/or the product ion candidates, an ion whose difference from a mass-to-charge ratio of a previously selected ion is within a predetermined range is excluded, and another candidate is selected.

6. The mass spectrometry method according to claim 1, wherein an MRM transition is determined for each of a plurality of target compounds, and further, for an MRM transition including a precursor ion candidate and/or a product ion candidate with a close mass-to-charge ratio between different compounds, it is noted that the mass-to-charge ratio is close to that of an MRM transition of another compound.

7. A mass spectrometry method, comprising:
performing a MS scan measurement of a target compound, and selecting one or more target ion candidates from among ions detected in the MS scan measurement based on a predetermined criterion regarding measured intensity,
wherein, in the MS scan measurement, a mass resolution in a higher mass-to-charge ratio or mass-to-charge ratio range is made lower than a mass resolution in a lower mass-to-charge ratio or mass-to-charge ratio range, in a mode that increases a measurement sensitivity in the higher mass-to-charge ratio or mass-to-charge ratio range.

8. A mass spectrometer, comprising:
a precursor ion candidate determination unit that performs a MS scan measurement of a target compound and selects one or more precursor ion candidates from among ions detected in the MS scan measurement based on a predetermined first criterion regarding measured intensity;
a product ion candidate determination unit that performs a MS/MS scan measurement using each of the one or more precursor ion candidates and selects product ion candidates from among product ions detected in the MS/MS scan measurement based on a predetermined second criterion regarding measured intensity;
an MRM transition determination unit that determines a pair of the precursor ion candidate and the product ion candidate as an MRM transition; and
a mass resolution setting unit that, in the MS scan measurement and/or the MS/MS scan measurement, makes a mass resolution in a higher mass-to-charge ratio or mass-to-charge ratio range lower than a mass resolution in a lower mass-to-charge ratio or mass-to-charge ratio range, in a mode that increases a measurement sensitivity in the higher mass-to-charge ratio or mass-to-charge ratio range.

9. A mass spectrometer, comprising:
a target ion determination unit that performs a MS scan measurement of a target compound and determines one or more target ions from among ions detected in the MS scan measurement based on a predetermined criterion regarding measured intensity; and
a mass resolution setting unit that, in the MS scan measurement and/or the MS/MS scan measurement, makes a mass resolution in a higher mass-to-charge ratio or mass-to-charge ratio range lower than a mass resolution in a lower mass-to-charge ratio or mass-to-charge ratio range, in a mode that increases a measurement sensitivity in the higher mass-to-charge ratio or mass-to-charge ratio range.
